(19) United States
(12) Patent Application Publication
(10) Pub. No.: US 2002/0084407 A1
(43) Pub. Date: Jul. 4, 2002

(54) Systems and methods for fabricating an electro-optical device used for image sensing

(75) Inventor: Thomas J. Grimsley, Fairport, NY (US)

Correspondence Address: LAHIVE & COCKFIELD, 28 STATE STREET, BOSTON, MA, 02109, US

(73) Assignee: Xerox Corporation

(21) Appl. No.: 09/750,426

(22) Filed: Dec. 28, 2000

(51) Int. Cl. G01J 3/50

(52) U.S. Cl. 250/226

(57) ABSTRACT

Methods and systems for making an electro-optical device suitable for use in an image forming system are described. The device includes photosensors, which are covered by filter layers that sense the presence of colors in, for example, a color document. The methods and systems involve the use of an inter-filter layer that serves to smooth a top surface of the electro-optical device between successive applications of the filter layers.

### TECHNICAL FIELD

The present invention relates generally to an electro-optical device, and specifically relates to the fabrication of an electro-optical device employed in an image forming system.

### BACKGROUND OF THE INVENTION

As copying and scanning of color documents becomes more prevalent, there has arisen a need for a solid-state electro-optical device suitable for sensing images, such as a silicon chip having an array of photosensors. For a photosensor to be sensitive to a specific primary color, a translucent filter layer, such as a polyimide or acrylic layer that has been dyed or pigmented to the specific primary color, may be applied on the surface of the chip. If a single photosensitive chip is intended to have multiple linear arrays of photosensors, each linear array being sensitive to one particular primary color, particular polyimide filter layers are applied to specific linear arrays, thereby creating a full-color photosensitive chip.

FIG. 1 is a plan view of a single photosensitive chip 10 of a general design found, for example, in a full-color photosensor scanner of the prior art. A typical design of a full-page-width scanner includes a plurality of chips 10 arranged to form an effective collinear array of photosensors, which extends across a page image being scanned. Each chip 10 is a silicon-based integrated circuit chip having defined in a main surface thereof at least three independently-functioning linear arrays of photosensors, each photosensor being here indicated as 14. The photosensors are disposed in at least three parallel rows that extend across a main dimension of the chip 10, these individual rows being shown as 16a, 16b, and 16c. Each individual row of photosensors on the chip 10 can be made sensitive to a particular color by applying to the particular rows 16a, 16b, and 16c a spectrally translucent filter layer that covers only the photosensors in a particular row. For example, the three rows of photosensors can be filtered with a different primary color, such as red, green, and blue. Generally, each individual photosensor 14 is adapted to output a charge or voltage signal indicative of the intensity of light of a certain type impinging thereon. Various structures, such as transfer circuits, or charge-coupled devices, are known in the art for processing signal output by the various photosensors 14.

One method of constructing a full-color photosensitive chip 10 is to first create a wafer having a relatively large number, such as one hundred or more, semiconductor structures, each structure corresponding to one chip 10. Filter layers may then be applied to the structures on the wafer. The filter layers may be applied as an even layer of translucent liquid to the entire wafer. This layer can then be etched away with, for example, a laser except in those areas on the chip structure where the filter is desired to be placed. Lithography can be used, where a photosensitive polymer containing a colorant is exposed to ultraviolet radiation through a mask and then patterned in a developer solution. For full-color chips, multiple layers of translucent filter material are applied to the wafer by spin coating, and then etched away as needed, to yield the three primary-color-filtered linear arrays of photosensors 14, as known to those of ordinary skill in the art. Only after the filter layers are applied as desired is the wafer “diced,” or sawed into individual chips.

In the foregoing method of fabricating a full-color photosensitive chip 10, a problem may arise when applying successive translucent filter layers. In particular, the process of applying a filter coat to the chip may cause the coat to be thicker on some photosensors than on others. Different thicknesses of the filter coat result in different intensities of light passing through the filter material to a particular photosensor. Such variations may result in diminished reproduction quality. For photosensors of a particular type on a single chip, it is desirable that the filter coat be of uniform thickness. In addition, when applying a filter coat, it is desirable to leave a smooth surface on the chip on which to apply the next filter coat. If the surface is not smooth, color reproduction quality can suffer.

One method of smoothing a first filter coat before applying a second filter coat involves grinding and/or polishing. Specifically, after the first filter coat is applied, another layer, such as a polyimide layer, is applied on top. Next, the polyimide layer is ground and/or polished down to the level of the first filter coat. Finally, the second filter coat is applied on the ground surface. One drawback of this technique, however, is that grinding and/or polishing the polyimide layer can be a time-consuming and inefficient process to smooth a surface of a photosensitive chip, resulting in waste and increased 20 production time.

### SUMMARY OF THE INVENTION

For the foregoing reasons, there exists in the art a need for systems and methods for fabricating an electro-optical device for sensing images in an image forming system. The methods can include smoothing a surface of a photosensitive chip by applying a smoothing or inter-filter layer. The inter-filter layer can be applied on a portion of a filter layer, and then left thereon, thereby smoothing the surface to ready it for the application of another filter layer.

In particular a method of fabricating an electro-optical device suitable for use in an image forming system is presented herein including applying a first filter layer above a substrate, and then applying an inter-filter layer over at least the first filter layer. The method also includes applying a second filter layer over at least a portion of the inter-filter layer without removing the inter-filter layer.

In accordance with the teachings of the present invention, a method of fabricating an electro-optical device, such as a linear array chip, is also presented herein that includes providing a substrate that functions as a foundation for the application of other layers. Next, a first photosensor and a second photosensor can be, if desired, inserted into the substrate of the electro-optical device. The photosensors can be embedded into the substrate to avoid creating topographical artifacts. A clear base layer is then optionally applied on the substrate. An area of the base layer that overlies the first photosensor is subsequently covered with a patterned first filter coat or layer. If the base layer is omitted, an area of the substrate that overlies the first photosensor is covered with a patterned first filter layer. The first filter layer preferentially allows light having a wavelength within a first range to reach the first photosensor. For this purpose, the first filter layer may contain a dye or pigment. Next, an inter-filter layer is applied on the patterned first filter layer and on an area of the base layer not covered by the patterned first filter layer, thereby smoothing a top surface of the electro-optical device. If the base layer is omitted, an inter-filter layer is applied on the patterned first filter layer and on an area of the substrate not covered by the patterned first filter layer. The inter-filter layer may be translucent, or colorless and may be composed of polyimide or acrylic. In another embodiment, the inter-filter layer can be colored and act as a filter itself. For example, a colored inter-filter layer can be used for cyan, magenta, and yellow filters. Cyan can be laid down over a first photosensor and then yellow can be utilized as an inter-filter layer, the combination yielding green. Subsequently, without removing the inter-filter layer, an area of the inter-filter layer that overlies the second photosensor is covered with a patterned second filter layer. The second filter layer preferentially allows light having a wavelength within a second range to reach the second photosensor. A second inter-filter layer may further be applied on the patterned second filter layer and on an area of the inter-filter layer not covered by the patterned second filter layer, thereby smoothing a second top surface of the electro-optical device. Additional filter layers may be applied in the above manner as needed.

The present invention also provides for an electro-optical device for image sensing having a substrate, and first and second photosensors disposed within the substrate. The device also includes an optional base layer disposed on the substrate. A patterned first filter layer is disposed on an area of the base layer that overlies the first photosensor. If the base layer is omitted, a patterned first filter layer is disposed on an area of the substrate that overlies the first photosensor. The first filter layer preferentially allows light having a wavelength within a first range to reach the first photosensor. The device further includes an inter-filter layer that is disposed permanently on the patterned first filter layer and on an area of the base layer not covered by the patterned first filter layer. If the base layer is omitted, the device further includes an inter-filter layer disposed permanently on the patterned first filter layer and on an area of the substrate not covered by the patterned first filter layer. The inter-filter layer thereby smoothes a top surface of the electro-optical device. The electro-optical device also includes a patterned second filter layer disposed over the second photosensor on the inter-filter layer. The second filter layer preferentially allows light having a wavelength within a second range to reach the second photosensor.

The electro-optical device may further include a second inter-filter layer disposed on the patterned second filter layer and on an area of the inter-filter layer not covered by the patterned second filter layer.

### BRIEF DESCRIPTION OF THE DRAWINGS

The aforementioned features and advantages, and other features and aspects of the present invention, will become better understood with regard to the following description and accompanying drawings.

FIG. 1 is a plan view of a conventional photosensitive chip.

FIGS. 2A-G illustrate in cross-section the steps for fabricating an electro-optical device for sensing images in an image forming system according to the teachings of the present invention.

FIG. 3 is a schematic flow chart diagram illustrating the steps for fabricating an electro-optical device according to the teachings of the present invention.

### DETAILED DESCRIPTION OF THE INVENTION

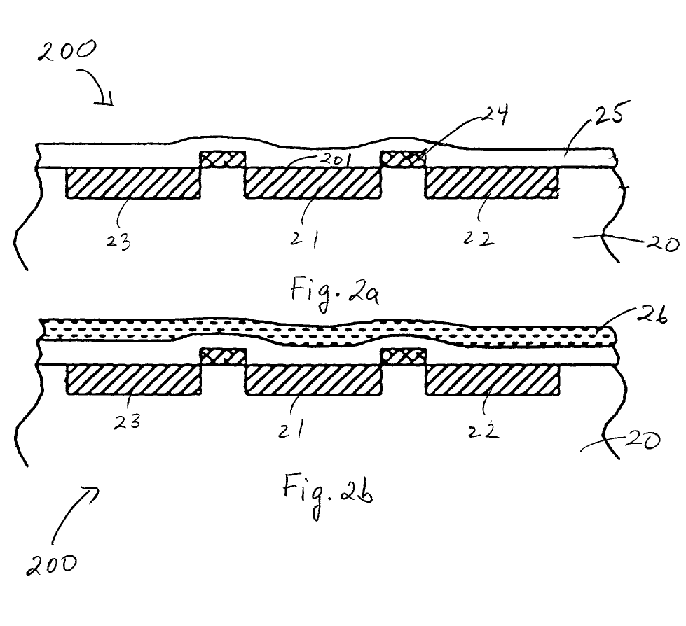

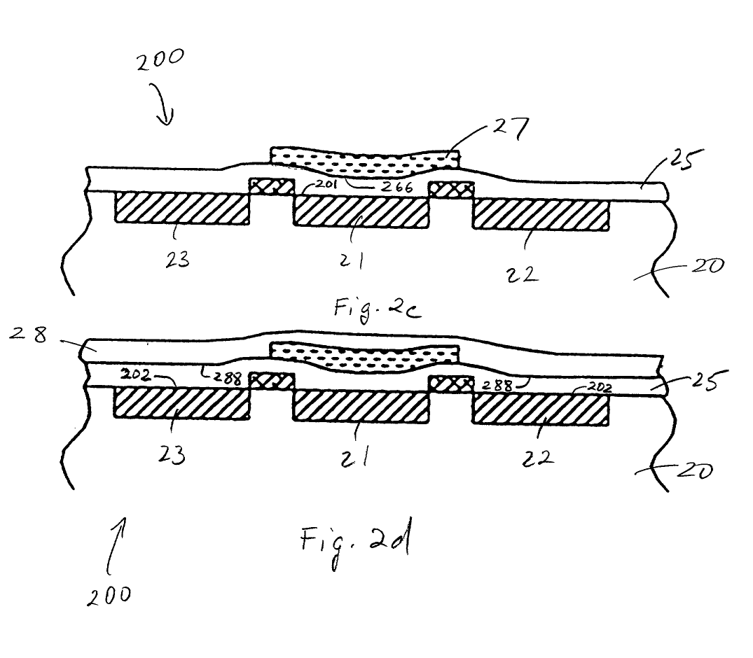

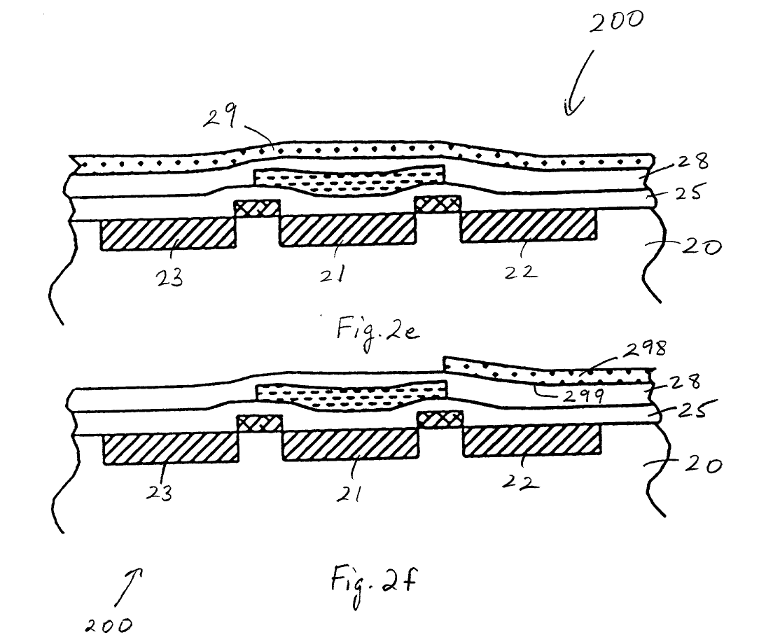

FIGS. 2A-G illustrate in cross-section an electro-optical device 200 for sensing images in an image forming system. Image forming systems include electrophotographic, electrostatic or electrostatographic, ionographic, and other types of image forming or reproducing systems that are adapted to capture and/or store image data associated with a particular object, such as a document. The system of the present invention is intended to be implemented in a variety of environments, such as in any of the foregoing types of image forming systems, and is not limited to the specific systems described below.

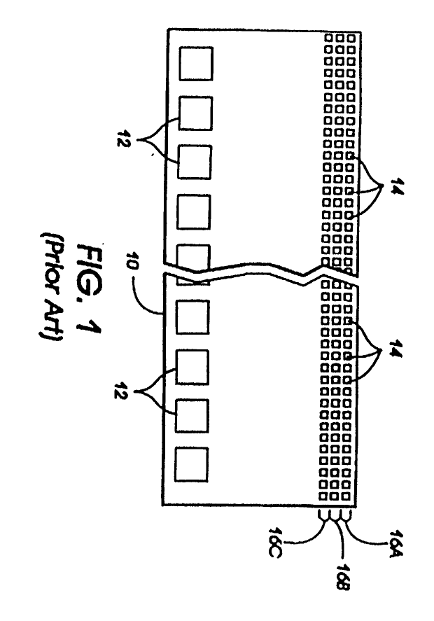

Referring to FIG. 2A, a photosensitive chip, such as the chip 10 of FIG. 1, can be fabricated by providing a substrate 20. A number of photosensors 21-23 can be disposed within the substrate 20. Some surface irregularities are also shown as the surface topography 24. With a purpose of smoothing the surface irregularities that form the surface topography 24, a clear base layer 25 may be disposed on the top surface of the substrate. In other embodiments, the application of this clear base layer 25 may be omitted. As used herein, the term “smoothing” is intended to include reducing, eliminating, or preventing the formulation of relatively sharp profiles of irregularities or other formed topographical structures present in one or more layers of the chip, so as to promote or enhance the transfer or flow of a fluid material, such as the filter material, across the surface of the chips without creating significant layer thickness irregularities as measured across the surface of the chip.

Referring now to FIG. 2B, a first filter layer 26 is disposed on top of the clear base layer 25. In one embodiment, the filter layer 26 may be applied using the technique of spin coating, as known to those of ordinary skill in the art. The filter layer 26 may contain, for example, acrylic, or polyimide and, in addition to filtering light, may act as a photoresist.

Referring to FIG. 2C, the first filter layer 26 is patterned. In particular, methods known to those of ordinary skill in the art, such as etching, may be used to form a patterned first filter layer 27. One of the aims of the filter coat patterning is to dispose the first filter layer 26 on an area 266 of the base layer 25 that overlies the first photo sensor 2 1. If the base layer 25 is omitted, the first filter layer 26 is disposed on an area 201 of the substrate 20 that overlies the first photosensor 2 1. Covering an area 266 of the base layer 25 that overlies the first photo sensor 21 with a patterned first filter layer 27 preferentially allows light having a wavelength within a first range to reach the first photo sensor 2 1. For example, the first filter layer 26 may be pigmented or dyed so that the only light that reaches the first photo sensor 21 is light having a wavelength within a small range of frequencies near the frequency of a first primary color, such as red, green, or blue.

Referring to FIG. 2D, an inter-filter layer 28 is disposed permanently over the patterned first filter layer 27 and on an area 288 of the base layer 25 not covered by the patterned first filter layer 27. If the base layer is omitted, an inter-filter layer 28 is disposed permanently on the patterned first filter layer 27 and at least on a portion 202 of the substrate 20, such as on an area 202 of the substrate 20 not covered by the patterned first filter layer 27. The term “inter-filter layer” as used herein is intended to include any suitable layer compatible with the other chip layers for allowing radiation to pass therethrough and for smoothing the topography (surface) of the chip 10. The inter-filter layer can be composed of any suitable material sufficient to allow radiation to pass therethrough, such as acrylic, polyimide or other optically transmissive film-forming polymer material. The inter-filter layer 28 acts to smooth the top surface of the assembly shown in FIG. 2C to prepare the surface for the application of a second filter layer. The inter-filter layer 28 is disposed permanently in the sense that it is not necessary to remove the inter-filter layer 28 by grinding and/or polishing to the level of the patterned first filter layer 27 prior to the application of the second filter layer. Instead, in what is an advantage of the present invention, the second filter layer is applied directly on the inter-filter layer 28 without having to remove or grind down the layer 28. In one embodiment, the inter-filter layer 28 is translucent and clear. In another embodiment, the inter-filter layer 28 may be translucent, but have a slight color. This latter embodiment may be useful in cases where the inter-filter layer is used to modify the incoming wavelengths in a similar fashion as the filters. The inter-filter layer 28 may be composed of any optically transmissive, film-forming polymer, such as acrylic, polyimide, polymethylmethacrylate (PMMA), and/or diazonovolak compounds.

Referring to FIG. 2E, a second filter layer 29 is disposed over the inter-filter layer 28. In one embodiment, the second filter layer 29 can also be applied using spin coating, as known to those of ordinary skill in the art. The second filter layer 29 may contain, for example, acrylic or polyimide and, in addition to acting as a filter of light, may act as a photoresist.

As illustrated in FIG. 2F, the second filter layer 29 can then be patterned. In particular, methods known to those of ordinary skill in the art, such as etching, may be used to form a patterned second filter layer 298. One of the aims of the patterning is to dispose the second filter layer 29 over at least a portion 299 of the inter-filter layer 28, such as on an area 299 of the inter-filter layer 28 that overlies the second photosensor 22. Covering an area 299 of the inter-filter layer 28 that overlies the second photosensor 22 with a patterned second filter layer 298 preferentially allows light having a wavelength within a second range to reach the second photosensor 22. For example, the second filter layer 29 may be pigmented or dyed so that only light having a wavelength within a small range of frequencies near the frequency of a second primary color reaches the second photosensor 22.

As illustrated in FIG. 2G, if additional layers are desired, a second inter-filter layer 270 can be disposed over the patterned second filter layer 298 and over an area 271 of the first inter-filter layer 28 not covered by the patterned second filter layer 298, as described above with reference to FIG. 2D.

Those of ordinary skill will readily recognize that any number of additional layers and intermediate inter-filter layers can be formed on the substrate. For example, a third filter layer pigmented to pass light corresponding to another primary color can be disposed over photosensor 23.

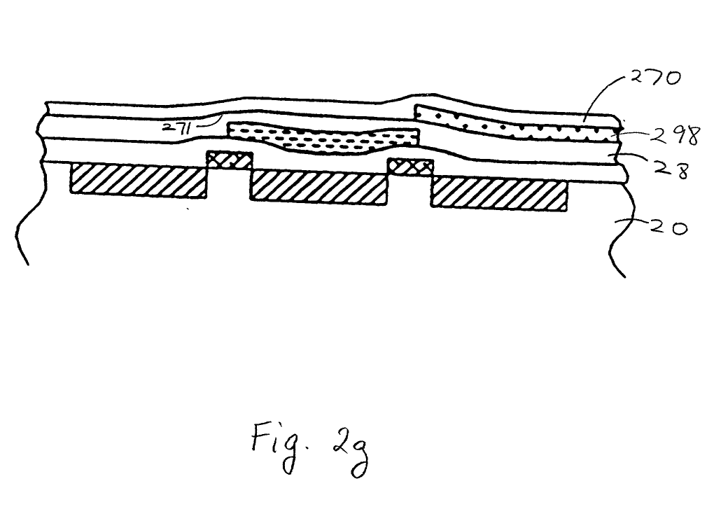

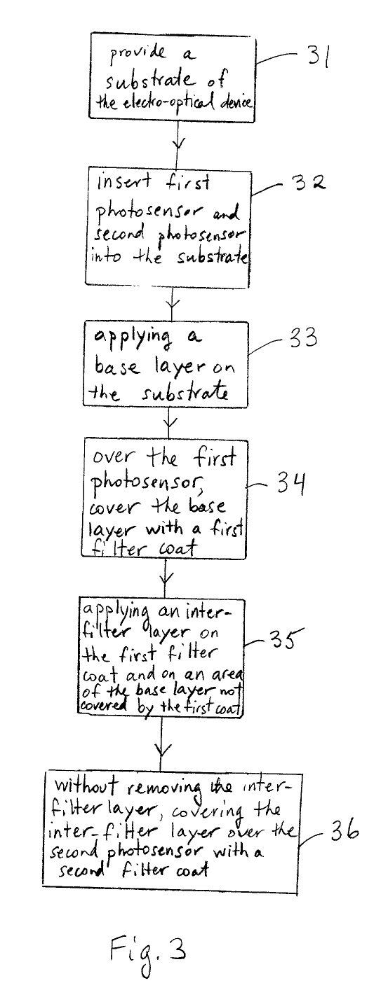

Referring to FIG. 3, a flow chart is shown illustrating the steps of fabricating an electro-optical device 200 for image sensing according to the teachings of the present invention. In step 31, a substrate 20 of the electro-optical device 200 is provided, which functions as a foundation on which additional layers are applied. In step 32, any suitable number of photosensors, such as a first photosensor 21 and a second photosensor 22, are inserted into the substrate 20 of the electro-optical device 200. In optional step 33, a base layer 25 is applied on the substrate 20 by, for example, spin coating. In other embodiments of the present invention, the step of applying a base layer 25 may be omitted. In step 34, an area of the base layer 25 that overlies one or more photosensors, such as the first photosensor 21, is covered with a patterned first filter layer 27. The first filter layer 26 preferably allows light having a wavelength within a first range to reach the first photosensor 21. To cover the base layer 25 over the first photosensor 21 with the patterned first filter layer 27, the layer 26 may initially be applied on the whole surface of the base layer 25 and subsequently etched to leave the patterned filter layer 27 disposed over the first photosensor 21. Next, in step 35, the inter-filter layer 28 is applied on the patterned first filter layer 27 and on an area of the base layer 25 not covered by the patterned first filter layer 27, thereby smoothing a top surface of the electro-optical device 200. Subsequently, in step 36, without removing the inter-filter layer 28, the inter-filter layer 28 may be covered over the second photosensor 22 with a second filter layer 29, the second filter layer 29 preferentially allowing light having a wavelength within a second range to reach the second photosensor 22. As in step 34, the second filter 29 may first be applied over the whole surface and then etched to leave the patterned second filter layer 298 over the second photosensor 22.

This process of smoothing the top surface with an inter-filter layer before applying a filter layer can be repeated as needed. For example, a second inter-filter layer can be added over the second filter layer for the coating of a third filter layer.

While the present invention has been described with reference to illustrative embodiments thereof, those skilled in the art will appreciate that various changes in form and detail may be made without departing from the intended scope of the present invention as defined in the appended claims.

What is claimed:

1. A method of fabricating an electro-optical device suitable for use in an image forming system, comprising the steps of:
a) applying a first filter layer above a substrate;
b) applying an inter-filter layer over at least the first filter layer; and
c) applying a second filter layer over at least a portion of the inter-filter layer without removing the inter-filter layer.

2. A method as in claim 1, further including the step of applying a base layer on the substrate before the step of applying a first filter layer.

3. A method as in claim 1, further including the step of mounting the electro-optical device in an image forming system.

4. A method as in claim 1, wherein the inter-filter layer is substantially colorless.

5. A method as in claim 1, wherein the inter-filter layer is composed of an optically transmissive, film-forming polymer material.

6. A method as in claim 1, wherein at least one of the first filter layer and the second filter layer contains a pigment.

7. A method as in claim 1, wherein the step of applying an inter-filter layer includes applying the inter-filter layer on an area of the substrate not covered by the first filter layer, thereby smoothing a top surface of the electro-optical device.

8. A method of making an electro-optical device for image sensing, the method comprising:
a) providing a substrate of the electro-optical device;
b) inserting a first photosensor and a second photosensor into the substrate of the electro-optical device;
c) applying a base layer on the substrate;
d) covering an area of the base layer that overlies the first photosensor with a patterned first filter layer, the first filter layer preferentially allowing light having a wavelength within a first range to reach the first photosensor;
e) applying an inter-filter layer on the first filter layer and on an area of the base layer not covered by the first filter layer, thereby smoothing a top surface of the electro-optical device; and
f) without removing the inter-filter layer, covering an area of the inter-filter layer that overlies the second photosensor with a patterned second filter layer, the second filter layer preferentially allowing light having a wavelength within a second range to reach the second photosensor.

9. A method as in claim 8, wherein at least one of the base layer and the inter-filter layer is colorless and translucent.

10. A method as in claim 8, wherein the inter-filter layer contains acrylic.

11. A method as in claim 8, wherein at least one of the first filter layer and second filter layer contains a pigment.

12. A method as in claim 8, further comprising applying a second inter-filter layer on the second filter layer and on an area of the inter-filter layer not covered by the second filter layer, thereby smoothing a second top surface of the electro-optical device.

13. A method as in claim 12, wherein at least one of the base layer and the second inter-filter layer is colorless and translucent.

14. A method as in claim 12, wherein the second inter-filter layer contains acrylic.

15. A method as in claim 12, wherein at least one of the first filter layer and second filter layer contains a pigment.

16. A method as in claim 12, wherein the electro-optical device includes a linear array chip.

17. An electro-optical device for image sensing, comprising:
a) a substrate;
b) a first photosensor and a second photosensor disposed within the substrate;
c) a patterned first filter layer disposed on an area of the substrate that overlies the first photosensor, the first filter layer preferentially allowing light having a wavelength within a first range to reach the first photosensor;
d) an inter-filter layer disposed permanently on the first filter layer and at least on a portion of the substrate, the inter-filter layer smoothing a top surface of the electro-optical device; and
e) a patterned second filter layer disposed on an area of the inter-filter layer that overlies the second photosensor, the second filter layer preferentially allowing light having a wavelength within a second range to reach the second photosensor.

18. An electro-optical device as in claim 19, wherein the inter-filter layer is colorless and translucent.

19. An electro-optical device as in claim 19, wherein the inter-filter layer contains acrylic.

20. An electro-optical device as in claim 19, further comprising a second inter-filter layer disposed on the patterned second filter layer and on an area of the inter-filter layer not covered by the patterned second filter layer, thereby smoothing a second top surface of the electro-optical device.
